(19) United States
(12) Patent Application Publication
(10) Pub. No.: US 2022/0399616 A1
(43) Pub. Date: Dec. 15, 2022

(54) ELECTROCHEMICAL DEVICE AND ELECTRONIC DEVICE

(71) Applicant: Ningde Amperex Technology Limited, Ningde City (CN)

(72) Inventor: Fangfang Li, Ningde City (CN)

(73) Assignee: Ningde Amperex Technology Limited, Ningde City (CN)

(21) Appl. No.: 17/708,713

(22) Filed: Mar. 30, 2022

(30) Foreign Application Priority Data
Jun. 9, 2021 (CN) 202110644998.9

(51) Int. Cl. H01M 50/533; H01M 50/186

(52) U.S. Cl. CPC H01M 50/533; H01M 50/186

(57) ABSTRACT

An electrochemical includes an electrode assembly, a packaging bag including a sealing region and a tab extending out of the sealing region. The electrode assembly is accommodated in the packaging bag. The tab includes a conductive piece which is electrically connected to the electrode assembly and a bonding piece which is disposed in the sealing region and located between the conductive piece and the packaging bag. The bonding piece includes an exposed portion extending out of the sealing region. Along a first direction that is approximately perpendicular to an extension direction of the conductive piece, the exposed portion includes a first step surface that is disposed on a surface of the conductive piece, a second step surface located on each of two sides of the first step surface, and a first connecting surface that connects the first step surface and the second step surface forming a first step portion.

### CROSS REFERENCE TO RELATED APPLICATIONS

This application claims the benefit of priority from China Patent Application No. 202110644998.9, filed on Jun. 9, 2021, the disclosure of which is hereby incorporated by reference in its entirely.

### TECHNICAL FIELD

This application relates to the technical field of batteries, and in particular, to an electrochemical device and an electronic device.

### BACKGROUND

A battery includes an electrode assembly and a tab. The electrode assembly is disposed in a packaging bag. The tab includes a conductive piece and a bonding piece. The conductive piece is electrically connected to the electrode assembly and extends out of the packaging bag. The bonding piece bonds to the conductive piece to implement sealing, and bonds to the packaging bag (such as an aluminum plastic film) to implement sealing. The bonding effect between the bonding piece and the conductive piece is one of key factors that affect the sealing effect of the packaging bag.

In an actual production process, the conductive piece is a structural element of a specific thickness. The bonding between the bonding piece and two opposite widthwise sides of the conductive piece poses relatively high requirements on the production process, and the bonding effect is hardly controllable. A thicker conductive piece makes the bonding effect less controllable, and therefore, affects the sealing effect of the packaging bag and makes an electrolytic solution prone to leak.

### SUMMARY

Embodiments of this application provide an electrochemical device and an electronic device to mitigate the problem of a poor sealing effect of a packaging bag caused by a poor bonding effect between a bonding piece and a conductive piece.

According to a first aspect, this application provides an electrochemical device, including an electrode assembly, a packaging bag, and a tab. The electrode assembly is accommodated in the packaging bag. The packaging bag includes a sealing region. The tab extends out of the sealing region. The tab includes a conductive piece and a bonding piece. The conductive piece is electrically connected to the electrode assembly. The bonding piece is disposed in the sealing region and located between the conductive piece and the packaging bag. The bonding piece includes an exposed portion extending out of the sealing region. Along a first direction, the exposed portion includes a first step surface, a second step surface located on each of two sides of the first step surface, and a first connecting surface that connects the first step surface and the second step surface. The first step surface, the first connecting surface, and the second step surface form a first step portion. The first step surface is disposed on a surface of the conductive piece. The first direction is perpendicular to an extension direction of the tab.

In a scenario in which a hot pressing process is adopted, a flat and neat blank of a bonding piece is affixed to surfaces of the conductive piece on two sides along a thickness direction of the conductive piece separately by using a hot pressing tool. The hot pressing tool is designed as a stepped structure. Therefore, different regions of the bonding piece are subjected to different stresses during the hot pressing. After completion of the hot pressing, along a second direction, on the surfaces of the conductive piece on both sides, the surface of the bonding piece forms the first step portion. The second direction is the thickness direction of the conductive piece. The first step portion includes the first step surface, the first connecting surface, and the second step surface. The first step surface is higher than the second step surface. In this way, even if the conductive piece is relatively thick, due to the stepped design, the gas (such as bubbles) at the joint between the bonding piece and the left surface of the conductive piece as well as the joint between the bonding piece and the right surface of the conductive piece can be exhausted. Therefore, the bonding between the bonding piece and the left and right surfaces of the conductive piece is more effective, thereby improving the sealing effect between the bonding piece and the conductive piece, and reducing the hazards of electrolyte leakage.

In an embodiment, an angle between the first connecting surface and the second step surface is θ1, and 30°≤θ1≤150°. Preferably, 30°<θ1≤90°. In this scenario, a greater stress exists between the first step surface of the bonding piece and the conductive piece, and the sealing and bonding between the bonding piece and the conductive piece are more effective.

In an embodiment, along the first direction, widths of the conductive piece, the first step surface, and the second step surface are w0, w1, and w2, respectively, and satisfy the following conditions: w1>w0; and w1≥w2. w0 is a horizontal distance between two sides of the conductive piece; w1 is a horizontal distance between intersection lines that are located on the two sides of the first step surface respectively, the intersection lines each being a line of intersection between the first step surface and one of the first connecting surfaces; and w2 is a horizontal distance between an intersection line and a sideline of the second step surface, the intersection line being a line of intersection between the first connecting surface located on one side of the first step surface and the second step surface.

In an embodiment, along a second direction, heights of the first step surface and the second step surface are H1 and H2 respectively, and H1>H2. H1 is a vertical distance between the first step surface and the conductive piece. H2 is a vertical distance between the second step surface and the conductive piece. The second direction is a thickness direction of the conductive piece. In this scenario, along the second direction, the bonding piece is a descending step from the first step surface to the second step surface. The first connecting surface and the second step surface exert a better bonding effect to both the left and right surfaces of the conductive piece.

In an embodiment, along the first direction, the exposed portion further includes a second connecting surface and a third step surface. The second connecting surface connects the second step surface and the third step surface. The second step surface, the second connecting surface, and the third step surface form a second step portion.

The exposed portion of the bonding piece may be made by the same hot pressing tool in one hot pressing process. For example, in addition to forming the first step surface, the first connecting surface, and the second step surface, the hot pressing tool further implements another stepped design. After completion of the hot pressing, along the second direction, on the surfaces of the conductive piece on both sides, the surface of the bonding piece forms the second step portion. The second step portion includes the second step surface, the second connecting surface, and the third step surface. The second step surface is higher than the third step surface. In this way, even if the bonding piece is relatively thick, due to the stepped design of the hot pressing tool, the thickness of the end of the bonding piece can be reduced, thereby being further conducive to exhausting the gas at the joint between the packaging bag and the left surface of the bonding piece as well as the joint between the packaging bag and the right surface of the bonding piece. Therefore, the bonding between the left and right surfaces of the bonding piece and the packaging bag is more effective, thereby improving the sealing effect between the packaging bag and the bonding piece, and reducing the hazards of electrolyte leakage.

In an embodiment, an angle between the second connecting surface and the third step surface is θ2, and 30°≤θ2≤150°. Preferably, 30°<θ2≤90°. In this scenario, a greater stress exists between the packaging bag and the bonding piece, and the sealing and bonding between the packaging bag and the bonding piece are more effective.

In an embodiment, along the first direction, a width of the third step surface is w3; a height of the third step surface is H3; w3 is a horizontal distance between an intersection line and a sideline of the third step surface, the intersection line being a line of intersection between the second connecting surface located on one side of the second step surface and the third step surface; H3 is a vertical distance between the third step surface and the conductive piece; and at least one of the following conditions is satisfied: w3≤w2; and H3<H2.

In this scenario, along the second direction, the bonding piece is a descending step from the second step surface to the third step surface. Along the first direction, the bonding piece is thinned, thereby improving the bonding effect between the packaging bag and the left and right surfaces of the bonding piece.

In an embodiment, the heights of the first step surface, the second step surface, and the third step surface satisfy conditions: 0.05 mm<H1≤0.4 mm; 0.05 mm<H2≤0.2 mm; and 0.05 mm<H4≤0.1 mm.

In an embodiment, the widths of the conductive piece, the first step surface, the second step surface, and the third step surface satisfy conditions: 9 mm≤w1≤60 mm; 0 mm<w1−w0≤2 mm; 2 mm≤w2≤4 mm; and 1 mm≤w3≤2 mm.

In an embodiment, the surface of the sealing region is a plane.

According to a second aspect, this application provides an electronic device. The electronic device includes a load and any one of the foregoing electrochemical devices. The electrochemical device supplies power to the load.

### BRIEF DESCRIPTION OF DRAWINGS

FIG. 1 is a schematic structural diagram of an electrochemical device according to an embodiment of this application;

FIG. 2 is a schematic structural diagram of a tab shown in FIG. 1;

FIG. 3 is a schematic sectional view of the tab shown in FIG. 2 and sectioned along an A-A direction;

FIG. 4 is a schematic structural diagram of an electrochemical device according to another embodiment of this application;

FIG. 5 is a schematic structural diagram of a tab shown in FIG. 4;

FIG. 6 is a schematic sectional view of the tab shown in FIG. 5 and sectioned along an A-A direction;

FIG. 7 is a schematic structural diagram of a region defined by a dashed line shown in FIG. 6;

FIG. 8 is a schematic structural diagram of a tab shown in FIG. 4 according to another embodiment;

FIG. 9 is a schematic structural diagram of a region defined by a dashed line shown in FIG. 8; and

FIG. 10 is a schematic structural diagram of an electrochemical device according to another embodiment of this application.

### DETAILED DESCRIPTION

To make the objectives, technical solutions, and advantages of this application clearer, the following describes the technical solutions of this application clearly with reference to embodiments and drawings. Evidently, the described embodiments are merely a part of but not all of the embodiments of this application. To the extent that no conflict occurs, the following embodiments and the technical features in each embodiment may be combined with each other based on the embodiments of this application.

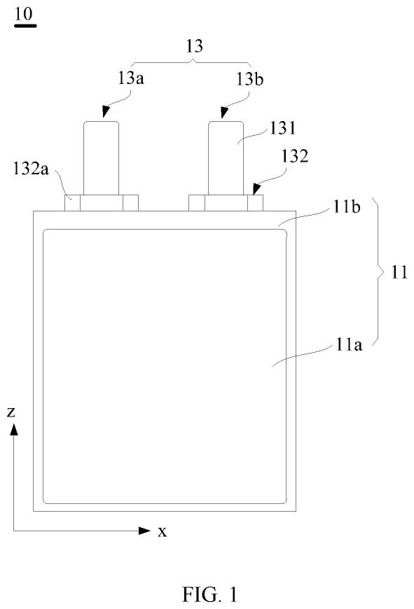

Referring to FIG. 1 to FIG. 3, in an embodiment of this application, the electrochemical device 10 includes a packaging bag 11, an electrode assembly (not shown in the drawing), and a tab 13.

The packaging bag 11 closes in to form a shape of the electrochemical device 10, and may be configured to define the appearance of the electrochemical device 10. The packaging bag 11 forms an reception cavity (not shown in the drawing). Internal components (such as the electrode assembly and an electrolytic solution) of the electrochemical device 10 are contained in the reception cavity. The packaging bag 11 serves to protect the internal components to improve the protection effect and safety.

The packaging bag 11 includes a body region 11a and a sealing region 11b. The electrode assembly and the electrolytic solution are disposed in the body region 11a. The sealing region 11b and the tab 13 extend out of one end of the body region 11a. The sealing region 11b is configured to seal the end of the body region 11a to prevent the electrolytic solution from leaking out of the end and prevent impurities such as water and oxygen outside the packaging bag 11 from entering the packaging bag 11. The sealing region 11b further seals a protruding region of the tab 13 to seal the joint between the packaging bag 11 and the tab 13.

In a scenario in which the electrochemical device 10 possesses positive and negative polarities, the electrode assembly includes a positive electrode plate, a negative electrode plate, and a separator disposed between the positive electrode plate and the negative electrode plate. The electrode assembly may be formed by winding or stacking several electrode plates. One end of the tab 13 extends into the packaging bag 11, and is electrically connected to the electrode plate of a corresponding polarity. The other end of the tab 13 extends out of one side of the packaging bag 11. Understandably, the electrical connection between the tab 13 and the electrode plate of the corresponding polarity includes two scenarios. One scenario is that the tab 13 is directly connected to the electrode plate. For example, the tab 13 and a current collector are welded together or integrally formed, so that the tab directly extends out of the electrode plate. The other scenario is that the tab 13 is indirectly connected to the electrode plate. For example, the tab 13 is connected to the electrode plate by welding an adapter and extends out of the packaging bag 11.

The tab 13 includes a first tab 13a and a second tab 13b. The first tab 13a is a negative tab, and the second tab 13b is a positive tab. The first tab 13a is electrically connected to the negative electrode plate, and extends from the inside of the packaging bag 11 to the outside of the packaging bag 11 along a third direction z. The second tab 13b is electrically connected to the positive electrode plate, and extends from the inside of the packaging bag 11 to the outside of the packaging bag 11. In other embodiments, the first tab 13a may be a positive tab, and the second tab 13b may be a negative tab. In some sections of this specification, the structure of the tab 13 according to an embodiment of this application is described by using just one of the tabs as an example.

The tab 13 includes a conductive piece 131 and a bonding piece 132. The conductive piece 131 is electrically connected to the electrode plate of the electrode assembly. Understandably, the structure and shape of the conductive piece 131 are not limited in the embodiments of this application. For example, the conductive piece 131 may be a rectangular strip structure. The dimensions of the structure may be adaptively set according to actual needs. The material of the structure includes but is not limited to aluminum, nickel, copper, and alloys such as nickel-plated copper. For example, the material of the conductive piece 131 of the positive tab may be aluminum or nickel-plated aluminum, and the material of the conductive piece 131 of the negative tab may be nickel-plated copper, thereby not only improving the performance of electrical connection to the negative electrode plate, but also increasing the structural strength of the negative tab.

The bonding piece 132 bonds to the conductive piece 131, and further bonds to the packaging bag 11 (for example, an aluminum plastic film as a soft packaging bag) to improve the sealing effect of the packaging bag 11 at the tab 13.

The bonding piece 132 is disposed on a first surface and a second surface of the conductive piece 131 separately. The first surface and the second surface are two opposite surfaces of the conductive piece 131 along a thickness direction of the conductive piece. The thickness direction of the conductive piece 131 may be referred to as a second direction y.

The second direction y changes adaptively depending on how the electrochemical device 10 is positioned. For example, as shown in FIG. 1, the second direction y is a vertical direction, the first surface of the conductive piece 131 is an upper surface, and the second surface of the conductive piece 131 is a lower surface; and the width direction of the conductive piece 131 (that is, perpendicular to the extension direction of the conductive piece 131) is the first direction x, and the length direction of the conductive piece 131 (that is, the extension direction of the conductive piece 131) is the third direction z. The first direction x is approximately perpendicular to the third direction z. “Approximately perpendicular” means that the angle between the first direction x and the third direction z is 80° to 100°.

Referring to FIG. 1 to FIG. 3, the bonding piece 132 includes an exposed portion 132a extending out of the sealing region 11b. Along the first direction x, the exposed portion 132a includes a first step surface 1321, a second step surface 1322, and a first connecting surface 1323. The first connecting surface 1323 is disposed between the first step surface 1321 and the second step surface 1322. The first step surface 1321 is disposed on the surface of the conductive piece 131. For example, the first step surface 1321 covers the surfaces of the conductive piece 131 on both sides. The second step surface 1322 is disposed alongside the first step surface 1321. The first step surface 1321 is connected to the second step surface 1322 by the first connecting surface 1323. For example, on the same side of the conductive piece 131, along the first direction x, the bonding piece 132 includes two second step surfaces 1322. The two second step surfaces 1322 are disposed on two opposite sides of the first step surface 1321 respectively, for example, the left side and the right side shown in FIG. 3. The first step surface 1321, the first connecting surface 1323, and the second step surface 1322 form a first step portion.

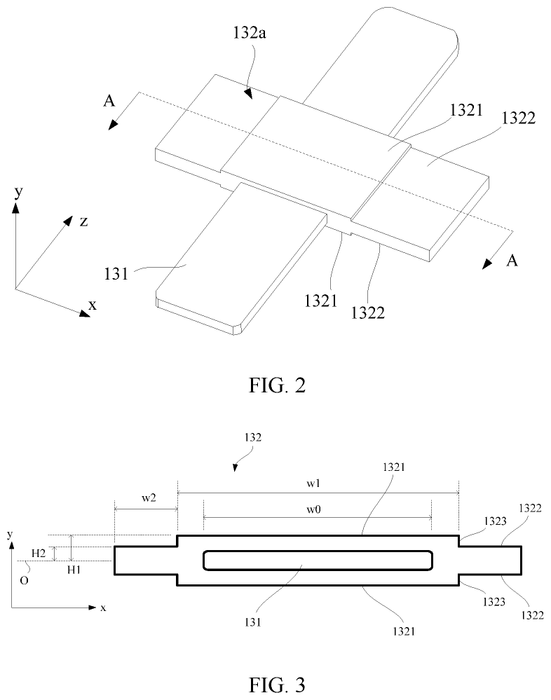

On the same side of the conductive piece 131, the first step surface 1321 is connected to the second step surface 1322 by the first connecting surface 1323. In the scenarios shown in FIG. 2 and FIG. 3, the height H1 of the first step surface 1321 is greater than the height H2 of the second step surface 1322, that is, H1>H2. H1 is a vertical distance between the first step surface 1321 and the conductive piece 131. H2 is a vertical distance between the second step surface 1322 and the conductive piece 131. Using a one-half division line O of the thickness of the conductive piece 131 as a benchmark, the vertical distance from each step surface to the division line O may be measured and used as the height of each step surface.

In some embodiments, the tab 13 may be made by a hot pressing process. For example, a flat and neat blank of the bonding piece 132 (such as fluid adhesive) is affixed to surfaces of the conductive piece 131 on both sides separately by using a hot pressing tool. The hot pressing tool is designed as a stepped structure. Therefore, different regions of the bonding piece 132 are subjected to different stresses during the hot pressing. After completion of the hot pressing, on the surfaces of the conductive piece 131 on both sides, the surface of the bonding piece 132 forms the first step portion. The first step portion includes the first step surface 1321, the first connecting surface 1323, and the second step surface 1322. The first step surface 1321 is higher than the second step surface 1322. In this way, even if the conductive piece 131 is relatively thick, due to the stepped design, the gas (such as bubbles) at the joint between the bonding piece 132 and the left surface of the conductive piece 131 as well as the joint between the bonding piece and the right surface of the conductive piece can be exhausted. Therefore, the bonding between the bonding piece 132 and the left and right surfaces of the conductive piece 131 is more effective, thereby improving the sealing effect between the bonding piece 132 and the conductive piece 131, and reducing the hazards of electrolyte leakage.

In some scenarios, the hot pressing surface of the hot pressing tool may be in direct contact with the surface of the blank of the bonding piece 132. On the hot pressing surface, it is not necessary to dispose a deformable flexible material such as rubber or polytetrafluoroethylene. The hot pressing tool includes but is not limited to a hot pressing copper slab.

Optionally, the bonding piece 132 may cover a weld region on the conductive piece 131, such as a position of welding between the conductive piece 131 and the adapter, so as to reduce the hazards of piercing the packaging bag 11 by weld burrs.

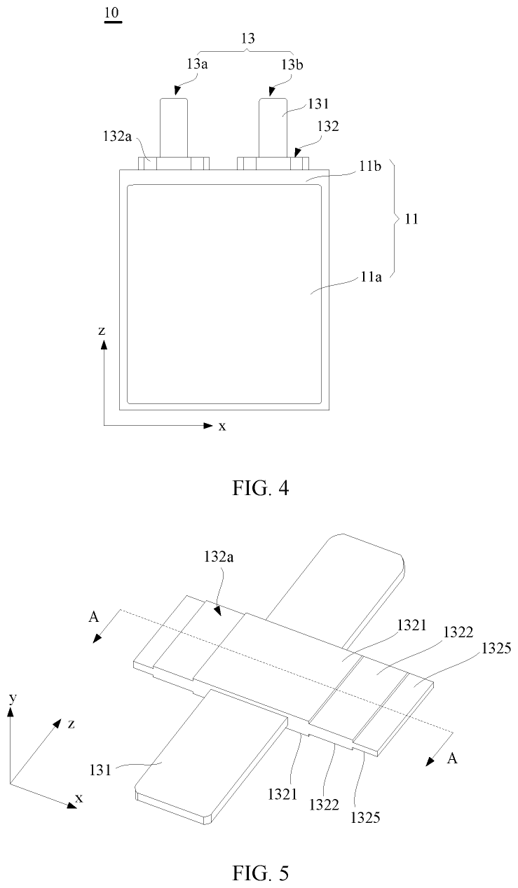

Still referring to FIG. 4 to FIG. 9, in some embodiments, the exposed portion 132a of the bonding piece 132 further includes a second connecting surface 1324 and a third step surface 1325. Along the first direction x, the second connecting surface 1324 is disposed between the second step surface 1322 and the third step surface 1325. On the same side of the conductive piece 131, the second step surface 1322 is connected to the third step surface 1325 by the second connecting surface 1324. The second step surface 1322, the second connecting surface 1324, and the third step surface 1325 form a second step portion.

The height H2 of the second step surface 1322 is greater than the height H3 of the third step surface 1325, that is, H3<H2. H3 is a vertical distance between the third step surface 1325 and the conductive piece 131.

In some embodiments, the exposed portion 132a of the bonding piece 132 may be made by the same hot pressing tool in one hot pressing process. For example, in addition to forming the first step surface 1321, the first connecting surface 1323, and the second step surface 1322, the hot pressing tool further implements another stepped design. After completion of the hot pressing, along the second direction y, on the surfaces of the conductive piece 131 on both sides, the surface of the bonding piece 132 forms the second step portion. The second step portion includes the second step surface 1322, the second connecting surface 1324, and the third step surface 1325. The second step surface 1322 is higher than the third step surface 1325. In this way, even if the bonding piece 132 is relatively thick, due to the stepped design of the hot pressing tool, the thickness of the end of the bonding piece 132 can be reduced, thereby being further conducive to exhausting the gas at the joint between the packaging bag 11 and the left surface of the bonding piece 132 as well as the joint between the packaging bag and the right surface of the bonding piece. Therefore, the bonding between the left and right surfaces of the bonding piece 132 and the packaging bag 11 is more effective, thereby further improving the sealing effect between the bonding piece 132 and the packaging bag 11, and reducing the hazards of electrolyte leakage.

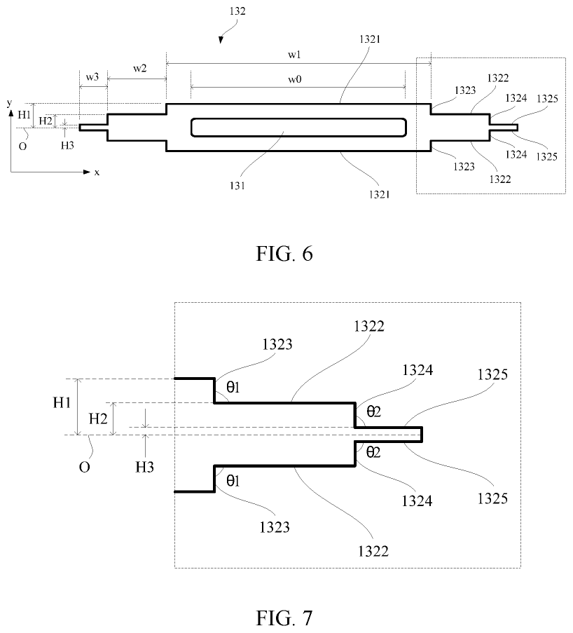

In the electrochemical device 10, as shown in FIG. 6 to FIG. 9, an angle between the first connecting surface 1323 and the second step surface 1322 is θ1, and 30°≤θ1≤150°. Optionally, 30°<θ1≤90°. In this scenario, a greater stress exists between the first step portion of the bonding piece 132 and the conductive piece 131, and the sealing and bonding between the bonding piece 132 and the conductive piece 131 are more effective.

In some embodiments, along the thickness direction of the conductive piece 131, that is, along the second direction y, the bonding pieces 132 located on the upper surface and lower surface of the conductive piece 131 may possess the same angle or different angles θ1. Along the length direction of the bonding piece 132, that is, along the first direction x, the angle θ1 between the first connecting surface 1323 to the left side of the conductive piece 131 and the second step surface 1322 may be the same as or different from the angle between the first connecting surface to the right side of the conductive piece and the second step surface. To simplify the manufacturing process, the value of the angle θ1 is the same anywhere on the bonding piece 132. Understandably, the value of the angle θ1 is adjustable by the stepped design of the hot pressing tool.

In the electrochemical device 10, as shown in FIG. 6 to FIG. 9, an angle between the second connecting surface 1324 and the third step surface 1325 is θ2, and 30°≤θ2≤150°. Optionally, 30°≤θ2≤90°. In this scenario, a greater stress exists between the packaging bag 11 and the bonding piece 132, and the sealing and bonding between the packaging bag 11 and the bonding piece 132 are more effective.

In some embodiments, along the thickness direction of the conductive piece 131, that is, along the second direction y, the bonding pieces 132 located on the upper surface and lower surface of the conductive piece 131 may possess the same angle or different angles θ2. Along the length direction of the bonding piece 132, that is, along the first direction x, the angle θ2 between the second connecting surface 1324 to the left side of the conductive piece 131 and the second step surface 1325 may be the same as or different from the angle between the second connecting surface to the right side of the conductive piece and the second step surface. To simplify the manufacturing process, the value of the angle θ2 is the same anywhere on the bonding piece 132. Understandably, the value of the angle θ2 is adjustable by the stepped design of the hot pressing tool.

In some specific embodiments, the angle θ1 between the first connecting surface 1323 and the second step surface 1322 and the angle θ2 between the second connecting surface 1324 and the third step surface 1325 are set independently.

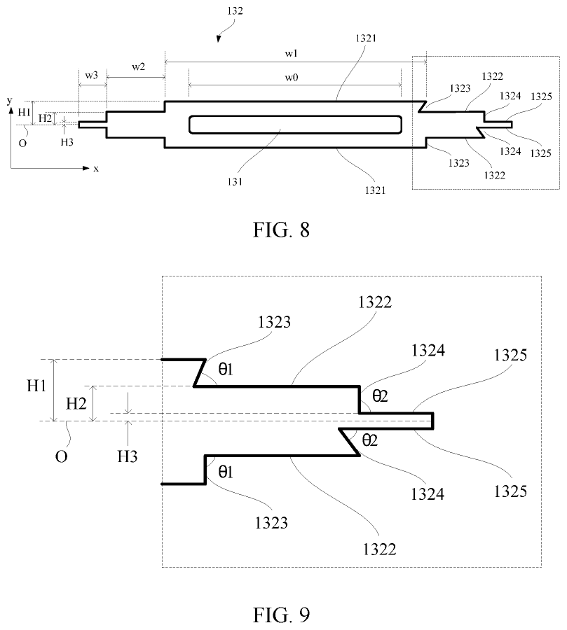

For example, in the both the scenario shown in FIG. 6 and the scenario shown in FIG. 7, the angle θ1 between the first connecting surface 1323 and the second step surface 1322 is 90°, and the angle θ2 between the second connecting surface 1324 and the third step surface 1325 is 90°. For another example, in the scenarios shown in FIG. 8 and FIG. 9, along the second direction y, on the upper lateral side of the conductive piece 131, the angle θ1 of the bonding piece 132 is an acute angle less than 90°, and the angle θ2 is 90°; and, on the lower lateral side of the conductive piece 131, the angle θ1 is 90°, and the angle θ2 is an acute angle less than 90°.

For the scenarios in which the angle θ1 and the angle θ2 are acute, in the process of preparing the bonding piece by hot pressing, the hot pressing tool is designed to implement a step at an angle of θ1, thereby helping the blank of the bonding piece 132 move toward the conductive piece 131. This can further exhaust the gas at the position of the angle, and make the bonding between the bonding piece 132 and the conductive piece 131 more effective at the position of the angle.

The material of the bonding piece 132 and the dimensions and shape of each part may be determined according to actual needs, and are not limited in the embodiments of this application.

For example, the material may be polypropylene or modified polypropylene.

For another example, in some scenarios, the heights of the step surfaces satisfy: 0.05 mm<H1≤0.4 mm; 0.05 mm<H2≤0.2 mm; and 0.05 mm<H4≤0.1 mm. Understandably, during measurement, using a one-half division line O of the thickness of the conductive piece as a benchmark, the vertical distance from each step surface to the division line O may be measured and used as the height of the step surface. The height of each step surface falling within the foregoing threshold range not only helps to control the thickness of the bonding piece 132 to be relatively small, but also makes the structural strength of the bonding piece 132 meet requirements.

For another example, as shown in FIG. 3, FIG. 6, and FIG. 8, along the first direction x, the width of the conductive piece 131 is w0, the width of the first step surface 1321 is w1, the width of the second step surface 1322 is w2, the width of the third step surface 1325 is w3, and the widths satisfy: w1>w0; w1≥w2; and w2≥w3. Understandably, w0 is a horizontal distance between two sides of the conductive piece 131; w1 is a horizontal distance between intersection lines that are located on the two sides of the first step surface 1321 respectively, the intersection lines each being a line of intersection between the first step surface 1321 and one of the first connecting surfaces 1323; and w2 is a horizontal distance between an intersection line and a sideline of the second step surface 1322, the intersection line being a line of intersection between the first connecting surface 1323 located on one side of the first step surface 1321 and the second step surface 1322.

In some scenarios, 9 mm≤w1≤60 mm; 0 mm<w1−w0≤2 mm; 2 mm≤w2≤4 mm; and 1 mm≤w3≤2 mm. When such thresholds are satisfied, relatively great widths of the conductive piece 131 and the bonding piece 132 can be obtained, the current-carrying capacity of the tab 13 is improved, and the narrow-width requirement of the electrochemical device 10 is met.

In some embodiments, the sealing region 11b in this application implements sealing by a two steps of hot pressing. In the first step, the bonding piece 132 is bonded onto the conductive piece 131 by the first step of hot pressing. A sealing head of the hot pressing tool in the first step of hot pressing is designed to be a stepped shape. Therefore, the bonding piece 132 subjected to the first step of hot pressing takes on the stepped shape described above. In the second step, a second step of hot processing is performed to implement sealing between the packaging bag 11 such as an aluminum plastic film and the bonding piece 132 subjected to the first step of hot pressing, and also implement sealing of the aluminum plastic film at other positions in the sealing region 11b. In the second step of hot pressing, the sealing head of the hot pressing tool is designed to be planar. Therefore, the surface of the sealing region 11b subjected to the second step of hot pressing is planar, but the bonding piece 132 extending out of the packaging bag 11 (that is, the exposed portion 132a of the bonding piece 132) still takes on a stepped shape.

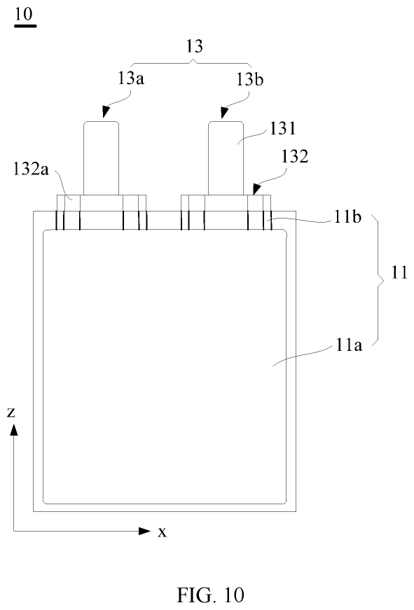

In some embodiments, the sealing region 11b in this application may be sealed by one step of hot pressing instead. After overlaying the surfaces of the conductive piece 131 on both sides, the bonding piece 132 extends into the packaging bag 11. Then the sealing region 11b is hot pressed by using the sealing head of the hot pressing tool. Due to the stepped design of the sealing head, as shown in FIG. 10, the surface of the sealing region 11b takes on a stepped shape. The bonding piece 132 extending out of the packaging bag 11 (that is, the exposed portion 132a of the bonding piece 132) takes on a stepped shape.

The electrochemical device 10 according to this application may be any device in which an electrochemical reaction occurs. Specific examples of the electrochemical device include all kinds of primary batteries, secondary batteries, fuel batteries, solar batteries, or capacitors. In particular, the electrochemical device 10 is a lithium secondary battery, a sodium secondary battery, a zinc secondary battery, or the like. The lithium secondary battery may include a lithium metal secondary battery, a lithium-ion secondary battery, a lithium polymer secondary battery, or a lithium-ion polymer secondary battery.

Another aspect of this application provides an electronic device. The electronic device includes a load and the electrochemical device 10 according to this application. The electrochemical device 10 supplies power to the load. The uses of the electrochemical device 10 according to this application are not particularly limited, and the electrochemical device may be used in any electronic device known in the prior art. In some embodiments, the electrochemical device 10 according to this application is applicable to, but without limitation: a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, and the like.

Because the electronic device contains the electrochemical device 10 according to any one of the foregoing embodiments, the electronic device can achieve the beneficial effects of the electrochemical device 10 according to the corresponding embodiment.

What is described above is merely a part of the embodiments of this application, and does not thereby limit the patent scope of this application. All equivalent structural variations made by using the content of this specification and the drawings hereof fall within the patent protection scope of this application as well.

Unless otherwise defined in the context, reference to a process, method, object, or device that “includes” or “comprises” a specific number of elements does not rule out a possibility that the process, method, object, or device further includes other equivalent elements. In addition, parts, features, and elements with the same name in different embodiments may have the same meaning or different meanings. The specific meanings of the parts, features, and elements need to be determined according to the interpretation thereof provided in a specific embodiment or further determined with reference to the context in the specific embodiment.

In addition, in the description of this application, a direction or a positional relationship indicated by the terms such as “center”, “longitudinal”, “transverse”, “length”, “width”, “thickness”, “upper”, “lower”, “before”, “after”, “left”, “right”, “vertical”, “horizontal”, “top”, “bottom”, “inner”, “outer”, “clockwise”, and “counterclockwise” is a direction or positional relationship based on the illustration in the drawings, and is merely intended for ease of describing the technical solutions in the corresponding embodiment of this application and for brevity of description, but not intended to indicate or imply that the indicated device or component must be located in the specified direction or constructed or operated in the specified direction. Therefore, such terms are not to be understood as a limitation on this application.

Although the terms such as “first”, “second”, and “third” are used herein to describe all kinds of information, the information is not limited by the terms. Such terms are merely used to distinguish between different types of information. A noun in the singular form preceded by “a”, “an”, “the” herein is intended to include the plural form thereof. The terms “or” and “and/or” are interpreted as inclusive, or mean any one or any combination of the items enumerated. No exception of the foregoing definitions occurs unless the combinations of components, functions, steps, or operations are inherently mutually exclusive in some implementations.

What is claimed is:

1. An electrochemical device, comprising:
an electrode assembly;
a packaging bag, wherein the electrode assembly is accommodated in the packaging bag, and the packaging bag comprises a sealing region;
a tab extending out of the sealing region, wherein the tab comprises a conductive piece and a bonding piece, the conductive piece is electrically connected to the electrode assembly, and the bonding piece is disposed in the sealing region and located between the conductive piece and the packaging bag; the bonding piece comprises an exposed portion extending out of the sealing region; along a first direction, the exposed portion comprises a first step surface, a second step surface located on each of two sides of the first step surface, and a first connecting surface connecting the first step surface and the second step surface; and the first step surface, the first connecting surface, and the second step surface form a first step portion, wherein the first step surface is disposed on a surface of the conductive piece, and the first direction is approximately perpendicular to an extension direction of the tab.

2. The electrochemical device according to claim 1, wherein an angle between the first connecting surface and the second step surface is θ1, and 30°≤θ1<150°.

3. The electrochemical device according to claim 1, wherein, along the first direction, widths of the conductive piece, the first step surface and the second step surface are w0, w1, and w2, respectively, and
w1>w0; and
w1≥w2;
wherein, w0 is a horizontal distance between two sides of the conductive piece; w1 is a horizontal distance between intersection lines that are located on the two sides of the first step surface respectively, the intersection lines each being a line of intersection between the first step surface and one of the first connecting surfaces; and w2 is a horizontal distance between an intersection line and a sideline of the second step surface, the intersection line being a line of intersection between the first connecting surface located on one side of the first step surface and the second step surface.

4. The electrochemical device according to claim 1, wherein, along a second direction, heights of the first step surface and the second step surface are H1 and H2 respectively, and H1>H2, wherein H1 is a vertical distance between the first step surface and the conductive piece, and H2 is a vertical distance between the second step surface and the conductive piece; and the second direction is a thickness direction of the conductive piece.

5. The electrochemical device according to claim 1, wherein, along the first direction, the exposed portion further comprises a third step surface and a second connecting surface connecting the second step surface and the third step surface; and the second step surface, the second connecting surface and the third step surface form a second step portion.

6. The electrochemical device according to claim 5, wherein an angle between the second connecting surface and the third step surface is θ2, and 30°≤θ2≤150°.

7. The electrochemical device according to claim 5, wherein, along the first direction, a width of the third step surface is w3; a height of the third step surface is H3; w3 is a horizontal distance between an intersection line and a sideline of the third step surface, the intersection line being a line of intersection between the second connecting surface located on one side of the second step surface and the third step surface; H3 is a vertical distance between the third step surface and the conductive piece along the second direction; and at least one of the following conditions is satisfied:
w3≤w2; and
H3<H2.

8. The electrochemical device according to claim 7, wherein 0.05 mm<H1≤0.4 mm; 0.05 mm<H2≤0.2 mm; and 0.05 mm<H4≤0.1 mm; and/or
9 mm≤w1≤60 mm; 0 mm<w1−w0≤2 mm; 2 mm≤w2≤4 mm; and 1 mm≤w3≤2 mm.

9. The electrochemical device according to claim 1, wherein a surface of the sealing region is a plane.

10. An electronic device, comprising a load and the electrochemical device. and the electrochemical device is configured to supply power to the load. Wherein the electrochemical comprises:
an electrode assembly;
a packaging bag, wherein the electrode assembly is accommodated in the packaging bag, and the packaging bag comprises a sealing region;
a tab, extending out of the sealing region, wherein the tab comprises a conductive piece and a bonding piece, the conductive piece is electrically connected to the electrode assembly, and the bonding piece is disposed in the sealing region and located between the conductive piece and the packaging bag; the bonding piece comprises an exposed portion extending out of the sealing region; along a first direction, the exposed portion comprises a first step surface, a second step surface located on each of two sides of the first step surface, and a first connecting surface that connects the first step surface and the second step surface; and the first step surface, the first connecting surface, and the second step surface form a first step portion, wherein the first step surface is disposed on a surface of the conductive piece, and the first direction is approximately perpendicular to an extension direction of the tab.

11. The electrochemical device according to claim 10 characterized in that an angle between the first connecting surface and the second step surface is θ1, and 30°≤θ1≤150°.

12. The electrochemical device according to claim 10, characterized in that along the first direction, widths of the conductive piece, the first step surface, and the second step surface are w0, w1, and w2, respectively, and satisfy the following conditions:
w1>w0; and
w1≥w2;
wherein, w0 is a horizontal distance between two sides of the conductive piece; w1 is a horizontal distance between intersection lines that are located on the two sides of the first step surface respectively, the intersection lines each being a line of intersection between the first step surface and one of the first connecting surfaces; and w2 is a horizontal distance between an intersection line and a sideline of the second step surface, the intersection line being a line of intersection between the first connecting surface located on one side of the first step surface and the second step surface.

13. The electrochemical device according to claim 10, characterized in that along a second direction, heights of the first step surface and the second step surface are H1 and H2 respectively, and H1>H2, wherein H1 is a vertical distance between the first step surface and the conductive piece, and H2 is a vertical distance between the second step surface and the conductive piece; and the second direction is a thickness direction of the conductive piece.

14. The electrochemical device according to claim 10, characterized in that along the first direction, the exposed portion further comprises a third step surface and a second connecting surface that connects the second step surface and the third step surface, and the second step surface, the second connecting surface, and the third step surface form a second step portion.

15. The electrochemical device according to claim 10, characterized in that an angle between the second connecting surface and the third step surface is θ2, and 30°≤θ2≤150°.

16. The electrochemical device according to claim 10, characterized in that along the first direction, a width of the third step surface is w3; a height of the third step surface is H3; w3 is a horizontal distance between an intersection line and a sideline of the third step surface, the intersection line being a line of intersection between the second connecting surface located on one side of the second step surface and the third step surface; H3 is a vertical distance between the third step surface and the conductive piece along the second direction; and at least one of the following conditions is satisfied:
w3≤w2; and
H3<H2.

17. The electrochemical device according to claim 10, characterized in that the heights of the first step surface, the second step surface, and the third step surface satisfy conditions: 0.05 mm<H1≤0.4 mm; 0.05 mm<H2≤0.2 mm; and 0.05 mm<H4≤0.1 mm; and/or
the widths of the conductive piece, the first step surface, the second step surface, and the third step surface satisfy conditions: 9 mm≤w1≤60 mm; 0 mm<w1−w0≤2 mm; 2 mm≤w2≤4 mm; and 1 mm≤w3≤2 mm.

18. The electrochemical device according to claim 10, characterized in that a surface of the sealing region is a plane.
